(19) United States
(12) Patent Application Publication
(10) Pub. No.: US 2026/0320331 A1
(43) Pub. Date: Oct. 15, 2026

(54) DATA INVERSION DETERMINATION DEVICE, PRINTING SYSTEM, AND DATA INVERSION DETERMINATION METHOD

(71) Applicant: Roland DG Corporation, Hamamatsu-shi (JP)

(72) Inventors: Yuuki NAKAJIMA, Hamamatsu-shi (JP); Yuki OKADO, Hamamatsu-shi (JP); Tamakazu KITAMURA, Hamamatsu-shi (JP); Kiriru RUTOSHIKIN, Hamamatsu-shi (JP)

(21) Appl. No.: 19/641,814

(22) Filed: Apr. 8, 2026

(30) Foreign Application Priority Data
Apr. 10, 2025 (JP) 2025-064874

(51) Int. Cl. G06K 15/02; G06V 30/148

(52) U.S. Cl. CPC G06K 15/1836; G06V 30/153

(57) ABSTRACT

A data inversion determination device includes an acquirer configured or programmed to acquire image data that is a print target, a character detector configured or programmed to detect a character from the image data acquired by the acquirer, and a determiner configured or programmed to estimate whether the character detected by the character detector is inverted to determine whether to invert the image data.

### CROSS REFERENCE OF RELATED APPLICATION

This application claims the benefit of priority to Japanese Patent Application No. 2025-064874 filed on Apr. 10, 2025. The entire contents of this application are incorporated herein by reference.

### BACKGROUND OF THE DISCLOSURE

### 1. Field of the Invention

The present disclosure relates to data inversion determination devices, printing systems, and data inversion determination methods.

### 2. Description of the Related Art

For example, Japanese Laid-open Patent Publication No. H7-61044 discloses a printer that performs printing on a transfer printing medium. An imager printed on the transfer printing medium is an inverted image obtained by mirror-inverting an image. The transfer printing medium can be transferred to a transfer object in a state where the inverted image is mirror-inverted by attaching the transfer printing medium on which the inverted image is printed to the transfer object through heat transfer.

In the printer, a user inputs printing an inverted image obtained by mirror-inverting an image on a transfer printing medium. When mirror-inverting the image is input, an inverted image is created from the image, and then, the inverted image can be printed on the transfer printing medium

Incidentally, in the invention disclosed in Japanese Laid-open Patent Publication No. H7-61044, the user determines whether to invert the image, and therefore, for example, there is a possibility that mirror-inverting an image that is not needed to be mirror-inverted is input by mistake.

### SUMMARY OF THE INVENTION

In view of the foregoing, example embodiments of the present invention provide data inversion determination devices, printing systems, and data inversion determination methods that enable proper determination of image data that is needed to be inverted.

A data inversion determination device according to an example embodiment of the present disclosure includes an acquirer configured or programmed to acquire image data that is a print target, a character detector configured or programmed to detect a character from the image data acquired by the acquirer, and a determiner configured or programmed to estimate whether the character detected by the character detector is inverted to determine whether to invert the image data.

According to the data inversion determination device, whether to invert the image data can be automatically determined based on information of whether the character included in the image data is inverted. Accordingly, the user is not required to manually invert the image data, and therefore, image data that is needed to be inverted can be properly determined.

A data inversion determination method according to another example embodiment of the present disclosure includes acquiring image data that is a print target, detecting a character from the image data acquired in the acquiring, and estimating whether the character detected in the detecting is inverted to determine whether to invert the image data.

According to example embodiments of the present disclosure, data inversion determination devices, printing systems, and data inversion determination methods that each can enable proper determination of image data that is needed to be inverted are provided.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a conceptual diagram illustrating a printing system according to a first example embodiment of the present invention.

FIG. 2 is a front view of a printer.

FIG. 3 is a cross-sectional view of the printer taken along a cross section III-III of FIG. 2.

FIG. 4 is a bottom view schematically illustrating configurations of bottom surfaces of a carriage and ink heads.

FIG. 5 is a block diagram of the printing system according to the first example embodiment of the present invention.

FIG. 6 is a diagram illustrating image data.

FIG. 7 is a diagram illustrating pre-processing image data.

FIG. 8 is a flowchart illustrating steps of determining whether to invert image data.

FIG. 9 is a diagram illustrating processing of inverting post-processing image data after RIP processing.

FIG. 10 is a block diagram of a printing system according to a second example embodiment of the present invention.

FIG. 11 is a diagram illustrating steps of inverting post-processing image data after RIP processing has been performed thereon to create inverted image data in the second example embodiment of the present invention.

FIG. 12 is a flowchart illustrating steps of determining whether to invert image data in the second example embodiment of the present invention.

FIG. 13 is a diagram illustrating image data in a modified example.

### DETAILED DESCRIPTION OF THE EXAMPLE EMBODIMENTS

Example embodiments of the present disclosure will be described below. Note that, as a matter of course, the example embodiments described herein are not intended to be particularly limiting of the present disclosure. Also, members/portions that have the same effect are denoted by the same sign and the overlapping description will be omitted or simplified as appropriate.

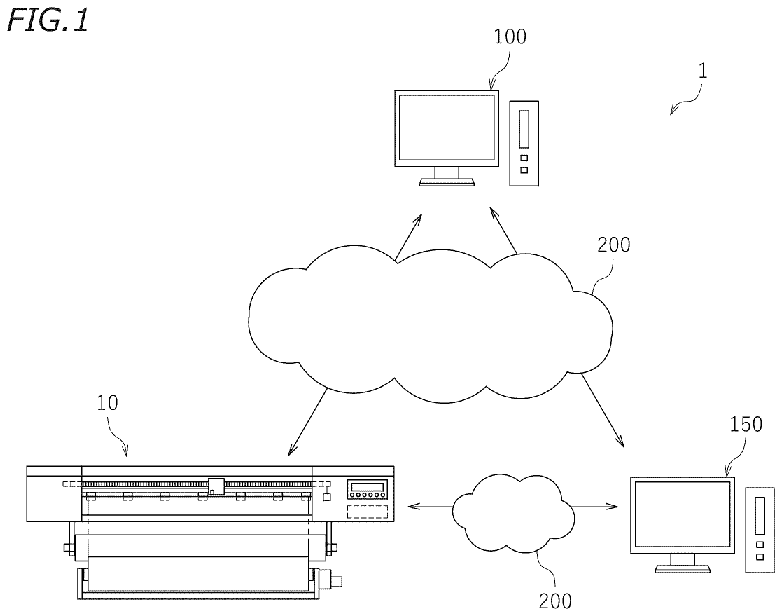

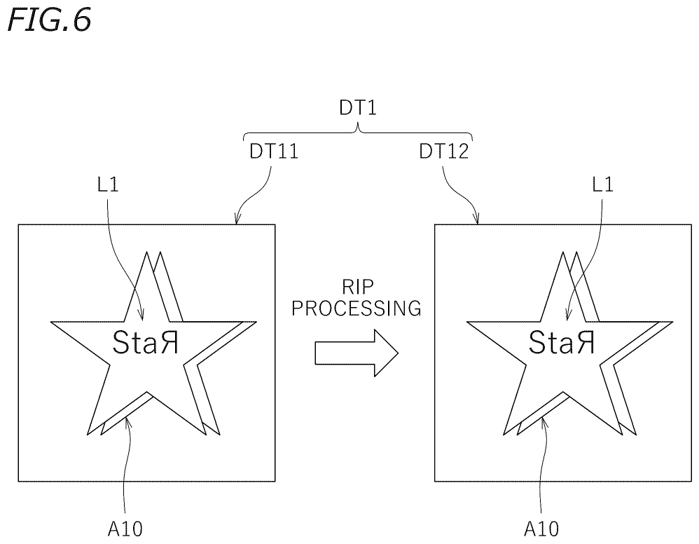

First, a first example embodiment will be described. FIG. 1 is a conceptual diagram illustrating a printing system 1 according to this example embodiment. In the printing system 1 according to this example embodiment, printing is performed based on image data DT1 (see FIG. 6) including an image that is a print target. In this example embodiment, as illustrated in FIG. 1, the printing system 1 includes a printer 10, a terminal 150, and a data inversion determination device 100. The printer 10, the terminal 150, and the data inversion determination device 100 will be described below in this order.

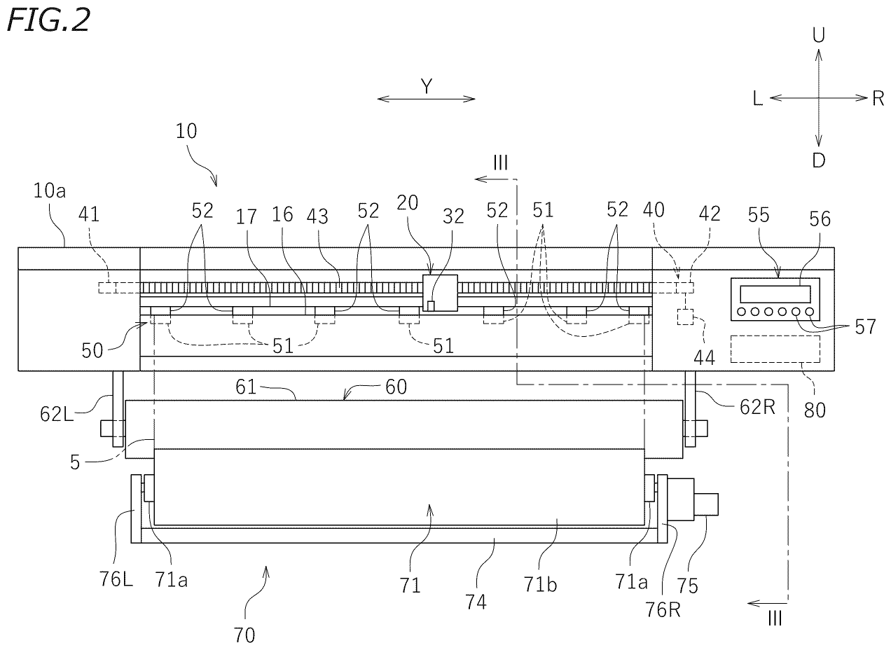

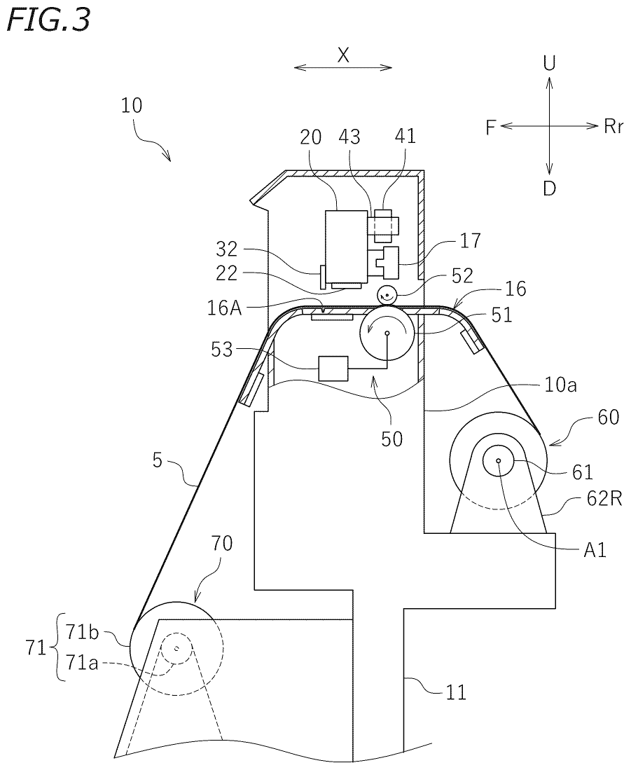

FIG. 2 is a front view of the printer 10 according to this example embodiment. FIG. 3 is a cross-sectional view of the printer 10 taken along a cross section III-III of FIG. 2. The reference signs F, Rr, L, R, U and D as used in the drawings refer to front, rear, left, right, up, and down of the printer 10, respectively. In the drawings, the reference sign Y denotes a main scanning direction and the reference sign X denotes a sub scanning direction. The main scanning direction Y is, for example, a left-right direction. The sub scanning direction X intersects (herein, is orthogonal to) the main scanning direction Y in plan view and is, for example, a front-rear direction. However, the directions described above are defined simply for convenience of description, do not limit an installation form of the printer 10, and do not limit the present disclosure.

The printer 10 is a printer of an ink jet system and is a so-called ink jet printer. However, a printing system of the printer 10 is not limited to an ink jet system, for example, may be a printer of a thermal system, and may be a printer of a laser system. In this example embodiment, the printer 10 is a printer that can perform transfer printing and a so-called direct-to-film (DTF) printer. Herein, the DTF printer prints an image on a transparent film for use in DTF.

In this example embodiment, the printer 10 performs printing on a rolled medium 5. Herein, the medium 5 is a transparent or translucent film for use in DTF. However, there is no particular limitation on a type of the medium 5 and the medium 5 may be paper, such as plain paper, ink jet printing paper, or the like, a cloth sheet, such as a woven fabric sheet, nonwoven fabric sheet, or the like, a metal sheet formed of aluminum, iron, or the like, or the like. The medium 5 is a medium that is rolled around a rotating shaft A1 (see FIG. 3) extending in the main scanning direction Y in a state where the medium 5 is installed in the printer 10. The medium 5 has a shape that allows the medium 5 to be wound on a winding roller 71 (see FIG. 3) of a winding device 70 that will be described later.

As illustrated in FIG. 3, the printer 10 includes a printer body 10a and a leg 11. As illustrated in FIG. 2, the printer body 10a includes a casing extending in the main scanning direction Y. As illustrated in FIG. 3, the leg 11 supports the printer body 10a. The leg 11 is provided on a bottom surface of the printer body 10a and extends downward from the printer body 10a. Note that, in FIG. 2, illustration of the leg 11 is omitted.

The printer 10 includes a support stand 16. The support stand 16 supports the medium 5 when printing is performed on the medium 5. Herein, the support stand 16 supports the rolled medium 5 in a developed state. The rolled medium 5 is placed in a developed state on the support stand 16. Printing on the medium 5 is performed on the support stand 16. The support stand 16 is a so-called platen. In this example embodiment, an upper surface of the support stand 16 (specifically, an upper surface of a central portion of the support stand 16 in the sub scanning direction X) extends in the main scanning direction Y and the sub scanning direction X. A portion of the support stand 16 at an upstream side (herein, a portion thereof at a rear side) has a lateral circular arc cross section and is curved downward toward rear. A portion of the support stand 16 at a downstream side (herein, a portion at a front side) has a lateral circular arc cross section and is curved downward toward front.

The printer 10 includes a guide rail 17, a carriage 20, and an ink head 22. The guide rail 17 is arranged above the support stand 16. As illustrated in FIG. 2, the guide rail 17 is arranged in parallel to the upper surface of the support stand 16 and extends in the main scanning direction Y. The carriage 20 is engaged with the guide rail 17. The carriage 20 is slidably provided on the guide rail 17 and is movable in the main scanning direction Y.

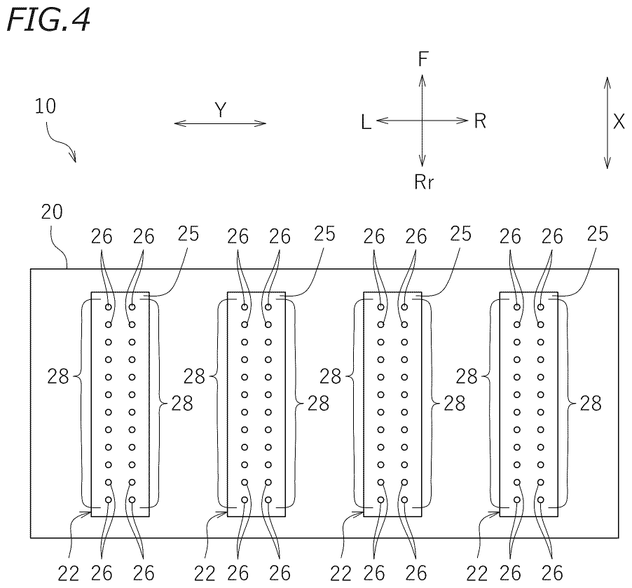

As illustrated in FIG. 3, the ink head 22 ejects an ink. The ink head 22 is provided on the carriage 20. The ink head 22 is supported by the carriage 20 such that a bottom surface thereof is exposed downward. There is no particular limitation on the number of the ink heads 22. FIG. 4 is a bottom view schematically illustrating configurations of bottom surfaces of the carriage 20 and the ink heads 22. In this example embodiment, as illustrated in FIG. 4, the number of the ink heads 22 is four, for example. The four ink heads 22 are arranged to align in the main scanning direction Y.

Each of the ink heads 22 includes a nozzle surface 25. The nozzle surface 25 defines the bottom surface of the ink head 22. A nozzle 26 that ejects an ink is provided in each of the nozzle surface 25. Multiple nozzles 26 are aligned in the sub scanning direction X. Herein, an array of the multiple nozzles 26 that align in the sub scanning direction X is referred to as a nozzle array 28. The number of the nozzle arrays 28 corresponding to one ink head 22 is two. However, there is no particular limitation on the number of the nozzle arrays 28 corresponding to one ink head 22, and the number of the nozzle arrays 28 corresponding to one ink head 22 may be one and may be three or more.

The ink that is ejected from the ink head 22 (herein, the nozzle 26) is, for example, an ink of one of colors of process color inks and spot color inks. Herein, the process color inks include, for example, a cyan ink, a magenta ink, a yellow ink, a black ink, or the like. The spot color inks are inks of some other colors than those of the process color inks. The spot color inks include, for example, a white ink, a clear ink, a gross ink, a primer ink, a fluorescent ink, a metallic ink, an orange ink, a red ink, a violet ink, a blue ink, a green ink, or the like. Herein, for one nozzle array 28, one color ink is ejected. Note that there is no limitation on materials of the inks and various types of materials that have been conventionally used as materials of inks used for an ink jet printer or the like can be used. The inks described above may be of, for example, solvent-based pigment ink or aqueous pigment ink. Alternatively, the inks described above may be of, for example, solvent-based dye ink, ultraviolet-curing type ink that cures when exposed to ultraviolet light, or the like.

As illustrated in FIG. 3, the printer 10 includes a sheet cutter 32. The sheet cutter 32 cuts a sheet of the medium 5 (herein, the medium 5 in a developed state) supported by the support stand 16. Herein, the sheet cutter 32 is used in cutting the medium 5 linearly in the main scanning direction Y. The medium 5 that is cut by the sheet cutter 32 is divided into two, that is, a portion at an upstream side (herein, a rear side) in the sub scanning direction X and a portion at a downstream side (herein, a front side) in the sub scanning direction X. Note that, in FIG. 4, illustration of the sheet cutter 32 is omitted.

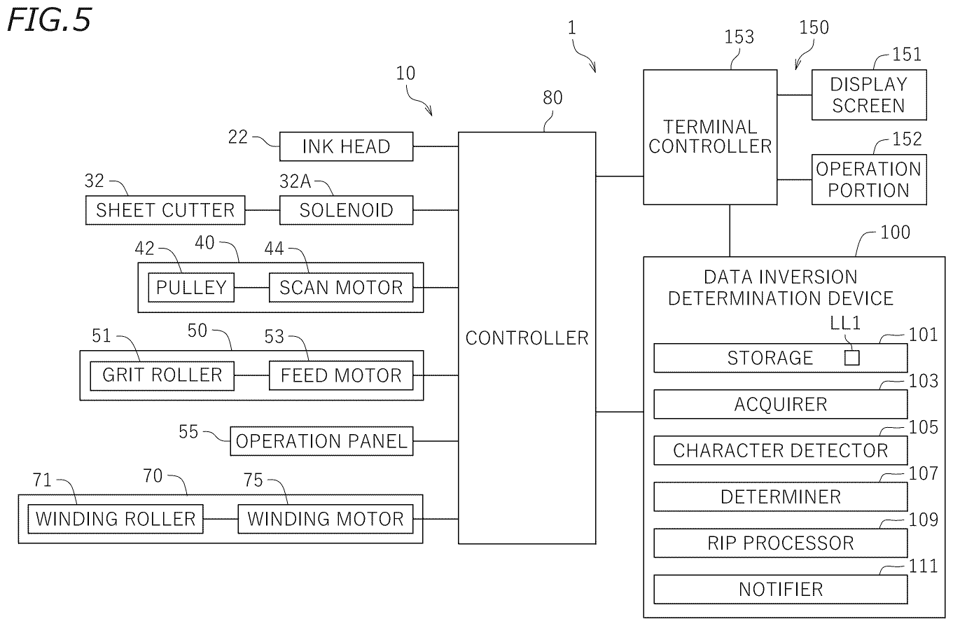

In this example embodiment, as illustrated in FIG. 3, the sheet cutter 32 is provided on the carriage 20. Therefore, the sheet cutter 32 is movable with the carriage 20 in the main scanning direction Y along the guide rail 17. The sheet cutter 32 can perform sheet cutting on the medium 5 by moving in the main scanning direction Y along the guide rail 17. The sheet cutter 32 is also movable in the up-down direction with respect to the carriage 20. For example, the sheet cutter 32 is attached to a solenoid 32A (see FIG. 5) provided on the carriage 20 and may be configured or programmed to be caused to be move in the up-down direction by turning on and off the solenoid 32A.

In this example embodiment, as illustrated in FIG. 3, a cutter grove 16A that extends in the main scanning direction Y is formed in an upper surface of the support stand 16. In plan view, the sheet cutter 32 is arranged in a position where the sheet cutter 32 overlaps with the cutter grove 16A in the sub scanning direction X. The sheet cutter 32 is configured to enter the cutter grove 16A through the medium 5 in performing sheet cutting of the medium 5 by the sheet cutter 32.

As illustrated in FIG. 2, the printer 10 includes a head moving mechanism 40 and a medium moving mechanism 50. The head moving mechanism 40 causes the medium 5 supported by the support stand 16 and the carriage 20, the ink head 22, and the sheet cutter 32 (which will be hereinafter also comprehensively referred to as the ink head 22 or the like) to relatively move in the main scanning direction Y, that is, the medium 5 moves relatively to the ink head 22 or the like and the ink head 22 or the like moves relatively to the medium 5 in the main scanning direction Y. Herein, the head moving mechanism 40 moves the ink head 22 or the like in the main scanning direction Y. Note that there is no particular limitation on a configuration of the head moving mechanism 40.

In this example embodiment, the head moving mechanism 40 includes left and right pulleys 41 and 42, an endless belt 43, and a scan motor 44. The pulley 41 is provided around a left end portion of the guide rail 17. The pulley 42 is provided around a right end portion of the guide rail 17. The belt 43 is wound on the pulley 41 and the pulley 42. As illustrated in FIG. 3, the belt 43 is fixed to an upper portion of a back surface of the carriage 20. As illustrated in FIG. 2, the scan motor 44 is connected to the right pulley 42. Herein, the scan motor 44 is driven and the pulley 42 rotates, and thus, the belt 43 runs between the pulley 41 and the pulley 42. Thus, the ink head 22 or the like moves in the main scanning direction Y.

The medium moving mechanism 50 causes the medium 5 and the ink head 22 or the like to relatively move in the sub scanning direction X, that is, the medium 5 moves relatively to the ink head 22 or the like and the ink head 22 or the like moves relatively to the medium 5 in the sub scanning direction X. Herein, the medium moving mechanism 50 moves a developed portion of the medium 5 supported by the support stand 16 in the sub scanning direction X. Nota that there is no particular limitation on a configuration of the medium moving mechanism 50.

In this example embodiment, as illustrated in FIG. 3, the medium moving mechanism 50 includes a grit roller 51, a pinch roller 52, and a feed motor 53. The grit roller 51 is provided on the support stand 16. Herein, the grit roller 51 is buried in the support stand 16 such that at least a portion of the grit roller 51 is exposed upward from the support stand 16. The pinch roller 52 presses the developed portion of the medium 5 from above and is arranged above the grit roller 51. The pinch roller 52 together with the grit roller 51 pinches the medium 5. The pinch roller 52 is opposed to the grit roller 51. The pinch roller 52 is movable in the up-down direction. Note that there is no particular limitation on respective installation positions and respective numbers of the grit roller 51 and the pinch roller 52. In this example embodiment, as illustrated in FIG. 2, seven grit rollers 51 and seven pinch rollers 52 are provided, for example. The multiple grit rollers 51 are arranged to align in the main scanning direction Y and the multiple pinch rollers 52 are arranged to align in the main scanning direction Y.

In this example embodiment, as illustrated in FIG. 3, the feed motor 53 is connected to the grit roller 51. In a state where the medium 5 is pinched between the grit roller 51 and the pinch roller 52, when the feed motor 53 is driven and the grit roller 51 rotates, the developed portion of the medium 5 is conveyed in the sub scanning direction X.

As illustrated in FIG. 3, the printer 10 includes a feeding device 60 including a supply roller 61. In the feeding device 60, the medium 5 in a state of being wound in a rolled shape is provided so as to be attached thereto and detached therefrom. The feeding device 60 supplies the medium 5 in a developed state to the support stand 16. The supply roller 61 is arranged in rear of the support stand 16 and below the support stand 16. As illustrated in FIG. 2, the supply roller 61 is formed in a cylindrical or columnar shape that extends in the main scanning direction Y. The medium 5 before printing is wound on a peripheral surface of the supply roller 61. A left end portion of the supply roller 61 is rotatably supported by a left guide plate 62L provided on the printer body 10a and a right end portion of the supply roller 61 is rotatably supported by a right guide plate 62R provided on the printer body 10a. The developed portion of the medium 5 is sent out toward the support stand 16 from the supply roller 61 by conveying the developed medium 5 to the downstream side in the sub scanning direction X by the medium moving mechanism 50. Note that, although the printer 10 does not include a motor that rotates the supply roller 61 in this example embodiment, the printer 10 may include such a motor.

As illustrated in FIG. 3, the printer 10 includes a winding device 70 that winds up the developed medium 5 that is supported by the support stand 16 into a rolled shape. In this example embodiment, the winding device 70 includes a winding roller 71 and a winding motor 75 (see FIG. 2).

The winding roller 71 winds up the developed medium 5. As illustrated in FIG. 2, the winding roller 71 is formed into a cylindrical or columnar shape that extends in the main scanning direction Y. As illustrated in FIG. 3, the winding roller 71 is arranged below the support stand 16 and further bellow the supply roller 61. As illustrated in FIG. 2, the printer 10 includes a first left side wall 76L and a first right side wall 76R that rotatably support the winding roller 71. The first left side wall 76L and the first right side wall 76R are provided in the printer body 10a. The winding roller 71 includes a support portion 71a that is supported by the first left side wall 76L and the first right side wall 76R and a cylindrical portion 71b that is provided on a peripheral surface of the support portion 71a and has a larger diameter than that of the support portion 71a. The medium 5 is wound up on a peripheral surface of the cylindrical portion 71b. The support portion 71a and the cylindrical portion 71b may be integrally formed and may be formed as separate bodies. A left end portion of the winding roller 71 is rotatably supported by the first left side wall 76L. A right end portion of the winding roller 71 is rotatably supported by the first right side wall 76R. The printer 10 includes a rail 74 that supports the first left side wall 76L and the first right side wall 76R. The rail 74 extends in the main scanning direction Y.

The winding motor 75 is connected to the winding roller 71 and rotates the winding roller 71. The winding motor 75 is indirectly connected to the winding roller 71 via an unillustrated speed reduction gear or the like. The winding roller 71 receives a driving force of the winding motor 75 and thus rotates.

In this example embodiment, as illustrated in FIG. 2, the printer 10 includes an operation panel 55 that is provided on a right end portion of the printer body 10a. A display screen 56 on which a state of the printer 10 or the like is displayed, an operation key 57 that is operated by a user, or the like are provided on the operation panel 55.

The printer 10 includes a controller 80. The controller 80 is configured or programmed to perform control related to printing or the like. There is no particular limitation on a configuration of the controller 80. The controller 80 is, for example, a microcomputer. Although there is no particular limitation on a configuration of a hardware of the microcomputer, the microcomputer includes, for example, an I/F, a CPU, a ROM, a RAM, and a storage. The controller 80 is provided inside the printer body 10a. However, the controller 80 may not be provided inside the printer body 10a. For example, the controller 80 may be a computer installed outside the printer body 10a, or the like. In this case, the controller 80 is communicably connected to a control board (not illustrated) of the printer 10 via a wire or wireless communication.

FIG. 5 is a block diagram of the printing system 1 according to this example embodiment. In this example embodiment, as illustrated in FIG. 5, the controller 80 is communicably connected to the ink head 22, the solenoid 32A connected to the sheet cutter 32, the head moving mechanism 40 (specifically, the scan motor 44), the medium moving mechanism 50 (specifically, the feed motor 53), the operation panel 55, and the winding device 70 (specifically, the winding motor 75). The controller 80 is configured or programmed to control the ink head 22, the solenoid 32A, the head moving mechanism 40, the medium moving mechanism 50, the operation panel 55, and the winding device 70.

The printer 10 according to this example embodiment has been described above. Next, the terminal 150 illustrated in FIG. 1 will be described. The terminal 150 is used by the user. The terminal 150 may be used to instruct the printer 10 to perform printing and may be used for operating the printer 10. In this example embodiment, as illustrated in FIG. 5, the terminal 150 is communicably connected to the controller 80 of the printer 10. As illustrated in FIG. 1, for example, the terminal 150 may be communicably connected to the printer 10 via the Internet 200.

The terminal 150 is realized, for example, by a desktop or laptop personal computer that is used by the user. The terminal 150 may be realized by a dedicated computer for the printer 10 and may be realized by a general-purpose computer. Moreover, the terminal 150 may be a mobile terminal, such as so-called smart phone, tablet terminal, or the like.

As illustrated in FIG. 5, the terminal 150 includes a display screen 151, an operation portion 152, and a terminal controller 153. For example, information related to the printer 10 communicably connected to the terminal 150 is displayed on the display screen 151. The operation portion 152 is operated by the user. For example, the user operates the operation portion 152 to select information on the display screen 151, change information displayed on the display screen 151, or perform like operation. The operation portion 152 is realized by a keyboard, a mouse, a touch panel, or the like.

The terminal controller 153 is, for example, a microcomputer. The terminal controller 153 includes, for example, an I/F, a CPU, a ROM, and a RAM. In this example embodiment, a dedicated application used for operating the printer 10 is installed in the terminal controller 153. The user starts the application via the operation portion 152 to display the application on the display screen 151. Thus, using the terminal 150, the user is enabled to instruct the printer 10 to perform printing or the like.

Next, the data inversion determination device 100 illustrated in FIG. 1 will be described. FIG. 6 is a diagram illustrating the image data DT1. The data inversion determination device 100 determines whether to invert the image data DT1 (see FIG. 6). As used herein, the term “invert” refers to inverting data left and right. For example, when transfer printing is performed by the printer 10, printing is performed on the medium 5 in a state where an image (which will be hereinafter also referred to as a transfer image A10 (see FIG. 6)) that the user desires to transfer on a transfer object, such as clothing or the like, is inverted. Depending on the user, when the user creates the image data DT1, there can be a case where the user creates image data in a state where the transfer image A10 has been previously inverted (which will be hereinafter also referred to as previously inverted data) or a case where the user creates image data in a state where the transfer image A10 has not been previously inverted (which will be hereinafter also referred to as previously non-inverted data). When it is supposed that the image data DT1 is the previously non-inverted data, there can be a case where, in printing using the printer 10, the image data DT1 is inverted and thus is printed. However, it is difficult to automatically determine whether the image data DT1 is the previously inverted data or the previously non-inverted data. Therefore, in this example embodiment, the data inversion determination device 100 automatically determines whether to invert the image data DT1.

For example, the printing system 1 is realized by a so-called cloud computing environment. In this case, the data inversion determination device 100 is a cloud server that is provided in the cloud computing environment. However, the printing system 1 may be realized by a so-called client-server environment. In this case, the data inversion determination device 100 is a server that is provided in the client-server environment. The printing system 1 may be realized by a so-called stand-alone environment. In this case, the data inversion determination device 100 is realized by a personal computer. The data inversion determination device 100 may be realized by a dedicated computer and may be realized by a general-purpose computer. Moreover, the data inversion determination device 100 may be realized by multiple computers in cooperation. The data inversion determination device 100 includes, for example, an I/F, a CPU, a ROM, a RAM, and a storage. As illustrated in FIG. 1, the data inversion determination device 100 is communicably connected to the printer 10 (specifically, the controller 80 (see FIG. 5)) and the terminal 150 (specifically, the terminal controller 153 (see FIG. 5)). Herein, the data inversion determination device 100 is communicably connected to the printer 10 and the terminal 150 via the Internet 200. In this example embodiment, the data inversion determination device 100 is a separate body from the terminal 150. However, the data inversion determination device 100 may be integrated with the terminal 150. That is, the data inversion determination device 100 and the terminal 150 may be realized by a common computer.

As illustrated in FIG. 5, the data inversion determination device 100 is configured or programmed to include a storage 101, an acquirer 103, a character detector 105, a determiner 107, a RIP processor 109, and a notifier 111. Note that each component of the data inversion determination device 100 may be realized by one or more processors and may be realized by a circuit.

In this example embodiment, as illustrated in FIG. 6, the data inversion determination device 100 can perform raster image processor (RIP) processing. As used herein, the term “RIP processing” refers to processing of converting image data (for example, vector data) prepared by the user in advance to raster data that can be read by the printer 10. For example, a RIP application software used for performing RIP processing has been installed in the data inversion determination device 100 in advance. The data inversion determination device 100 can perform RIP processing by starting the RIP application software.

As illustrated in FIG. 6, the image data DT1 includes pre-processing image data DT11 and post-processing image data DT12. The pre-processing image data DT11 is the image data DT1 before RIP processing is performed thereon. The pre-processing image data DT11 is, for example, vector data. The post-processing image data DT12 is the image data DT1 after RIP processing has been performed thereon. The post-processing image data DT12 is, for example, raster data and data that can be read by the printer 10. Herein, the data inversion determination device 100 creates the post-processing image data DT12 by performing RIP processing on the pre-processing image data DT11. The printer 10 reads the post-processing image data DT12 and thus performs printing of the transfer image A10 (for example, the inverted transfer image A10) on the medium 5.

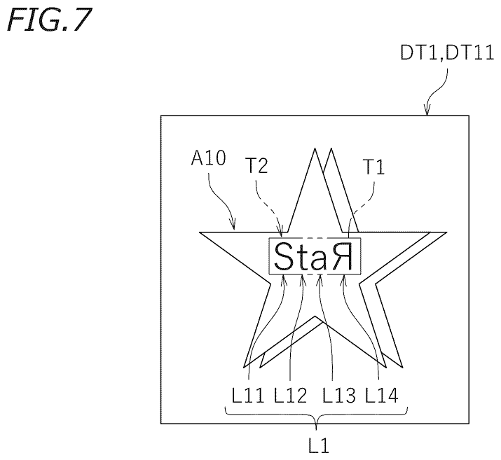

FIG. 7 is a diagram illustrating the pre-processing image data DT11. Incidentally, as illustrated in FIG. 7, there is a possibility that the image data DT1 includes one or more characters L1. A so-called character library LL1 (see FIG. 5) has been stored in advance in the storage 101 of the data inversion determination device 100. Something recognized as a character is registered in the character library LL1. As used herein, the term “character” refers to a character that has been registered in the character library LL1 in advance. Characters include, for example, hiragana (a type of Japanese phonetic script), katakana (another type of Japanese phonetic script), kanji (Chinese characters), alphabets, symbols, or the like. Characters may include characters of a language used in each country or region. The data inversion determination device 100 determines whether to invert the image data DT1, based on the character L1 included in the image data DT1.

In this example embodiment, as illustrated in FIG. 7, the pre-processing image data DT11 that is vector data includes a text object T1. The text object T1 is an object indicating that the pre-processing image data DT11 includes the character L1. Herein, the character L1 included in the image data DT1 is the character L1 included in the text object T1 in the pre-processing image data DT11. The text object T1 includes inversion setting information T2 indicating whether the character L1 included in the text object T1 is inverted. Herein, the inversion setting information T2 includes inverted information and non-inverted information. The inverted information is information indicating that the character L1 included in the text object T1 is inverted. The non-inverted information is information indicating that the character L1 included in the text object T1 is not inverted. The inversion setting information T2 is information that is added to each character L1 included in the text object T1. In an example of FIG. 7, the inversion setting information T2 of characters L11, L12, and L13 of the characters L1 is the non-inverted information and the inversion setting information T2 of a character L14 is the inverted information. In this example embodiment, the data inversion determination device 100 estimates whether the character L1 included in the image data DT1 is inverted, based on the inversion setting information T2 of the text object T1 to determine whether to invert the image data DT1.

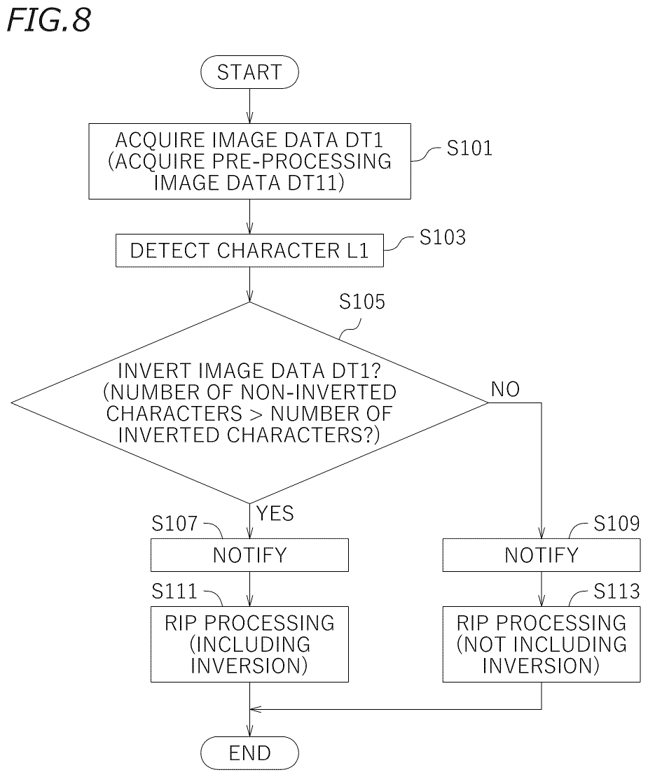

Next, steps of determining whether to invert the image data DT1 will be described with reference to a flowchart of FIG. 8.

First, in Step S101 of FIG. 8, the acquirer 103 of FIG. 5 acquires the image data DT1. Herein, the acquirer 103 acquires, as the image data DT1, the pre-processing image data DT11 of FIG. 7. There is no particular limitation on an acquisition destination to which the acquirer 103 acquires the pre-processing image data DT11. For example, the pre-processing image data DT11 is created by the user and may be stored in the storage 101 of FIG. 5 in advance. In this case, the acquirer 103 acquires the pre-processing image data DT11 stored in the storage 101. However, the pre-processing image data DT11 may be created by an external computer (for example, the terminal 150 (see FIG. 1)) communicably connected to the data inversion determination device 100. In this case, the acquirer 103 acquires, as the image data DT1, the pre-processing image data DT11 from the external computer.

Next, in Step S103 of FIG. 8, the character detector 105 of FIG. 5 detects the character L1 included in the image data DT1, as illustrated in FIG. 7. Herein, the character detector 105 detects the character L1 from the pre-processing image data DT11 of the image data DT1 acquired by the acquirer 103 and detects the number of characters L1. In this example embodiment, as described above, the pre-processing image data DT11 is vector data including the text object T1. Therefore, the character detector 105 can detects the character L1 included in the pre-processing image data DT11 by detecting the text object T1. Herein, the characters L1 included in the text object T1 can be divided for each character L1. Therefore, the character detector 105 detects the number of the characters L1 included in the pre-processing image data DT11 by detecting the text object T1. For example, in the example of FIG. 7, the number of the characters L1 is four.

Next, in Step S105 of FIG. 8, the determiner 107 of FIG. 5 determines whether to invert the image data DT1. In this example embodiment, the determiner 107 estimates whether the character L1 included in the image data DT1 is inverted to determine whether to invert the image data DT1. Herein, the determiner 107 determines whether to invert the image data DT1, based on whether the character L1 included in the pre-processing image data DT11 is inverted. The determiner 107 can determine whether the character L1 included in the text object T1 is inverted, based on the inversion setting information T2 included in text object T1 of the pre-processing image data DT11 that is vector data.

In this example embodiment, the determiner 107 calculates the number of the characters L1 the inversion setting information T2 of which is the inverted information among the characters L1 included in the text object T1 (which will be hereinafter referred to as the number of inverted characters) and calculates the number of the characters L1 the inversion setting information T2 of which is the non-inverted information among the characters L1 included in the text object T1 (which will be hereinafter referred to as the number of non-inverted characters). For example, in FIG. 7, the character L1 the inversion setting information T2 of which is the inverted information is the character L14 and the number of inverted characters is one. The characters L1 the inversion setting information T2 of which is the non-inverted information are the characters L11, L12, and L13 and the number of non-inverted characters is three. The determiner 107 determines whether the number of non-inverted characters is larger than the number of inverted characters. Herein, when the number of non-inverted characters is larger than the number of inverted characters, many of the characters L1 included in the image data DT1 are not inverted characters, and therefore, it is estimated that the transfer image A10 of the image data DT1 is an image that has not been yet inverted. In this case, the determiner 107 determines to invert the image data DT1. In inverting the image data DT1, the process proceeds to subsequent Step S107 of FIG. 8 next.

On the other hand, in Step S105, when the number of inverted characters is equal to or larger than the number of non-inverted characters, many of the characters L1 included in the image data DT1 are already inverted characters, and therefore, it is estimated that the transfer image A10 of the image data DT1 is an already inverted image. In this case, the determiner 107 determines not to invert the image data DT1. When the image data DT1 is not inverted, the process proceeds to Step S109 of FIG. 8 next.

Note that, in Step S105, in determining whether to invert the image data DT1, the number of the characters L1 included in the text object T1 (which will be hereinafter referred to as a total number of characters) and the number of inverted characters (or the number of non-inverted characters) may be compared to each other. In this case, the determiner 107 may be configured or programmed to determine, when the number of inverted characters is equal to or larger than a half of the total number of characters (for example, ½ of the total number of characters), not to invert the image data DT1 and determine, when the number of inverted characters is less than the half of the total number of characters, to invert the image data DT1. The determiner 107 may be also configured or programmed to determine, when the number of non-inverted characters is equal to or larger than the half of the total number of characters, to invert the image data DT1 and determine, when the number of non-inverted characters is less than the half of the total number of characters, not to invert the image data DT1.

In Step S107 and Step S109, the notifier 111 of FIG. 5 notifies the user of a determination result obtained by the determiner 107 in Step S105. In Step S107, the notifier 111 notifies the user of a determination result of inverting the image data DT1. In Step S109, the notifier 111 notifies the user of a determination result of not inverting the image data DT1. Note that there is no particular limitation on a notification destination which the notifier 111 notifies of a determination result. In this example embodiment, the notifier 111 notifies the user of the determination result via the terminal 150 of FIG. 1. For example, the notifier 111 transmits the determination result to the terminal 150. At this time, in the terminal 150, the terminal controller 153 of FIG. 5 displays the determination result on the display screen 151 of FIG. 5. The user knows whether to invert the image data DT1 by visually recognizing the determination result displayed on the display screen 151. Note that a notification step of Step S107 and Step S109 may be omitted.

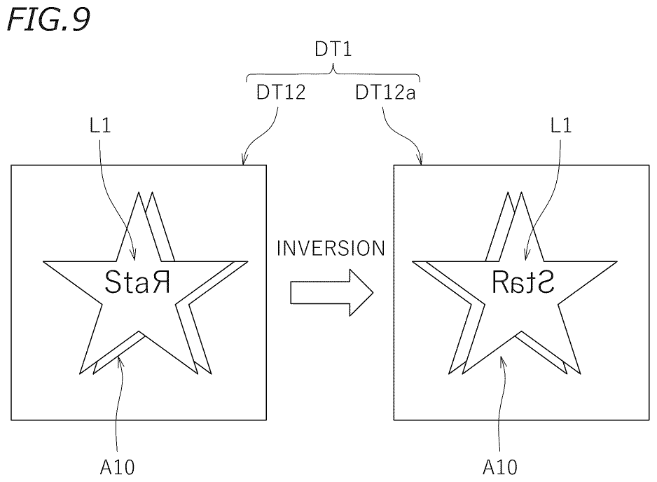

In this example embodiment, as illustrated in FIG. 8, after notification in Step S107, the process proceeds to Step S111. FIG. 9 is a diagram illustrating processing of inverting the post-processing image data DT12 after RIP processing. In Step S111, the RIP processor 109 of FIG. 5 perform inversion after performing RIP processing on the pre-processing image data DT11 to create inverted post-processing image data DT12a. Herein, as illustrated in FIG. 6, the RIP processor 109 RIP-processes the pre-processing image data DT11 to create the post-processing image data DT12. Thereafter, as illustrated in FIG. 9, the RIP processor 109 inverts the post-processing image data DT12 (specifically, inverts the post-processing image data DT12 left and right) to create the inverted post-processing image data DT12a.

Note that, although, in this example embodiment, in Step S109, the inverted post-processing image data DT12a is created by inverting the post-processing image data DT12 after RIP processing, for example, the inverted post-processing image data DT12a may be created by performing RIP processing after inverting the pre-processing image data DT11. For example, in Step S109, the pre-processing image data DT11 is inverted to create inverted post-processing image data. Thereafter, RIP processing may be performed on the inverted post-processing image data to create the inverted post-processing image data DT12a.

In this example embodiment, as illustrated in FIG. 8, after notification in Step S109, the process proceeds to Step S113. In Step S113, as illustrated in FIG. 6, the RIP processor 109 creates the post-processing image data DT12 without inverting after RIP processing is performed on the pre-processing image data DT11.

Note that, in this example embodiment, the notifier 111 may be configured or programmed to determine, when the notifier 111 notifies the determination result in Step S107 and S109 in FIG. 8, whether to continue RIP processing. That is, a function of stopping continuation of RIP processing when the determination result of which the notifier 111 has been notified is not a determination result that the user expects may be provided. In this case, the terminal 150 may be configured or programmed to display, for example, together with the determination result, a message indicating that RIP processing is to be started, a “continue” button, and a “stop” button on the display screen 151, based on notification by the notifier 111. Herein, the user operates the operation portion 152 to select the “continue” button or the “stop” button displayed on the display screen 151. When the “continue” button is selected, Step S111 or Step S113 may be executed. On the other hand, when the “stop” button is selected, Step S111 and Step S113 are not executed and the steps of the flowchart of FIG. 8 may be terminated.

Note that the inverted post-processing image data DT12a created in Step S111 or the post-processing image data DT12 created in Step S113 (which will be hereinafter also simply referred to as the post-processing image data DT12 or DT12a) is transmitted to the printer 10 by the data inversion determination device 100. In the printer 10, the printer 10 receives the post-processing image data DT12 or DT12a and prints the transfer image A10 on the medium 5, based on the post-processing image data DT12 or DT12a. The transfer image A10 printed on the medium 5 then can be an inverted image.

As has been described above, in this example embodiment, as illustrated in FIG. 1, the printing system 1 includes the data inversion determination device 100 and the printer 10. As illustrated in FIG. 5, the data inversion determination device 100 is configured or programmed to include the acquirer 103, the character detector 105, and the determiner 107. The acquirer 103 acquires the image data DT1 that is a print target in Step S101 of FIG. 8. The character detector 105 detects the character L1 (see FIG. 7) from the image data DT1 acquired by the acquirer 103 in Step S103 of FIG. 8. In Step S105 of FIG. 8, the determiner 107 estimates whether the character L1 detected by the character detector 105 is inverted to determine where to invert the image data DT1. Thus, whether to invert the image data DT1 can be automatically determined based on information of whether the character L1 included in the image data DT1 is inverted. Accordingly, the user is not required to manually invert the image data DT1, and therefore, the image data DT1 that needs to be inverted can be properly determined.

In this example embodiment, as illustrated in FIG. 6, the image data DT1 includes the pre-processing image data DT11 that is vector data before RIP processing is performed thereon. As illustrated in FIG. 7, in the pre-processing image data DT11, the character L1 is set as the text object T1 included in the vector data. The character detector 105 detects, as the character L1, a portion of the pre-processing image data DT11 detected as the text object T1. As described above, the text object T1 is an object that is recognized as a character. Accordingly, the character L1 can be properly detected from the pre-processing image data DT11 by detecting the text object T1.

In this example embodiment, as illustrated in FIG. 7, the text object T1 includes the inversion setting information T2 indicating whether the character L1 is inverted. The determiner 107 determines whether to invert the image data DT1, based on the inversion setting information T2. Whether the character L1 is inverted can be properly estimated by using the inversion setting information T2 in the above-described manner. Accordingly, whether it is needed to invert the image data DT1 can be properly determined.

In this example embodiment, the inversion setting information T2 includes the inverted information indicating that the character L1 is inverted and the non-inverted information indicating that the character L1 is not inverted. In Step S105 of FIG. 8, the determiner 107 determines, when the number of characters the inversion setting information T2 of which is the non-inverted information (the number of non-inverted characters) is larger than the number of characters the inversion setting information T2 of which is the inverted information (the number of inverted characters), to invert the image data DT1. When the number of non-inverted characters is larger than the number of inverted characters, it is estimated that it is highly likely that the transfer image A10 of the image data DT1 is an image before being inverted and it is needed to invert the image data DT1. Accordingly, whether it is needed to invert the image data DT1 can be more properly determined by comparing the number of non-inverted characters and the number of inverted characters to each other.

In this example embodiment, when it is determined by the determiner 107 to invert the image data DT1, the RIP processor 109 (see FIG. 5) of the data inversion determination device 100 RIP-processes the pre-processing image data DT11 and invert the pre-processing image data DT11 to create the inverted post-processing image data DT12a indicated in FIG. 9 in Step S111 of FIG. 8. The printer 10 is configured to perform printing on the medium 5, based on the post-processing image data DT12 or DT12a created by the RIP processor 109 of the data inversion determination device 100. As described above, the inverted post-processing image data DT12a that has become the inverted transfer image A10 can be created by determining whether to invert data after being RIP-processed, in accordance with the determination result of the determiner 107.

In this example embodiment, the notifier 111 of the data inversion determination device 100 (see FIG. 5) notifies the user of the determination result obtained by the determiner 107 in Step S107 and Step S109 of FIG. 8. Thus, whether to invert data after being RIP-processed can be notified to the user in advance.

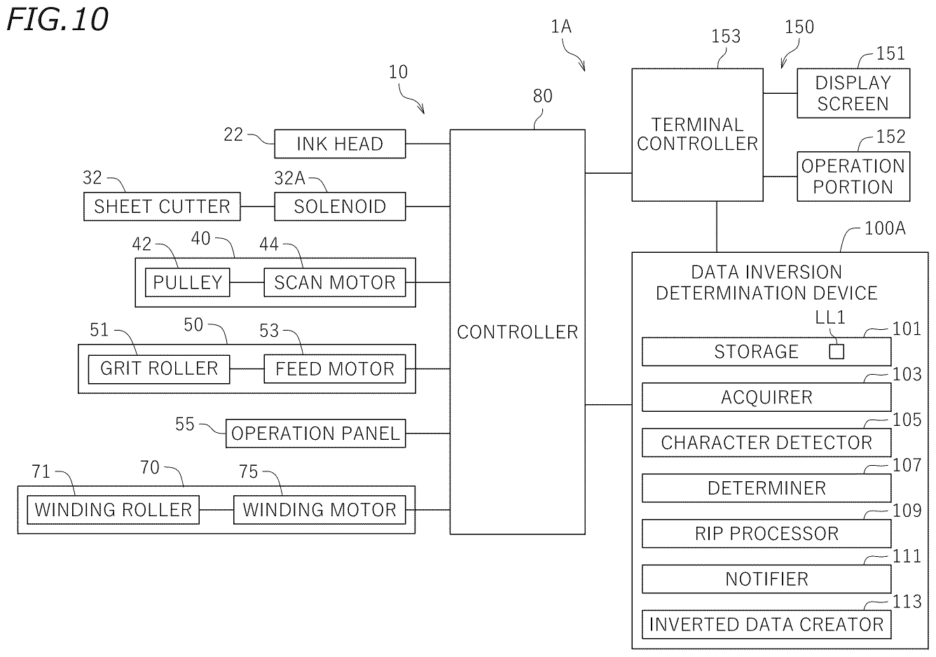

Next, a data inversion determination device 100A that a printing system 1A according to a second example embodiment includes will be described. FIG. 10 is a block diagram of the printing system 1A according to the second example embodiment. As illustrated in FIG. 10, similar to the data inversion determination device 100 according to the first example embodiment, the data inversion determination device 100A includes the storage 101, the acquirer 103, the character detector 105, the determiner 107, the RIP processor 109, and the notifier 111. The data inversion determination device 100A further includes an inverted data creator 113. The data inversion determination device 100A has a similar configuration to that of the data inversion determination device 100 according to the first example embodiment, except that the data inversion determination device 100A includes the inverted data creator 113.

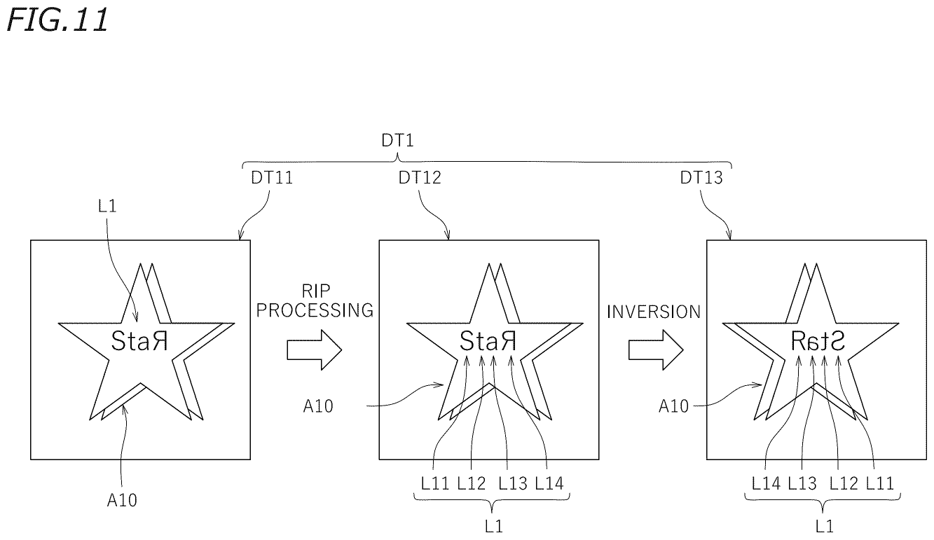

FIG. 11 is a diagram illustrating steps of inverting the post-processing image data DT12 after RIP processing has been performed thereon to create inverted image data DT13. In this example embodiment, as illustrated in FIG. 11, the data inversion determination device 100A determines whether to invert the image data DT1 from the post-processing image data DT12 after RIP processing has been performed on the pre-processing image data DT11 in the image data DT1. As described above, the post-processing image data DT12 is raster data and, unlike vector data, does not include the text object T1 (see FIG. 7). Therefore, in this example embodiment, using a technology of optical character recognition, a character included in the image data DT1 is detected. Optical character recognition is also referred to as OCR. For example, using the character library LL1 stored in the storage 101 of FIG. 10, a character registered in the character library LL1 is detected by the OCR technology.

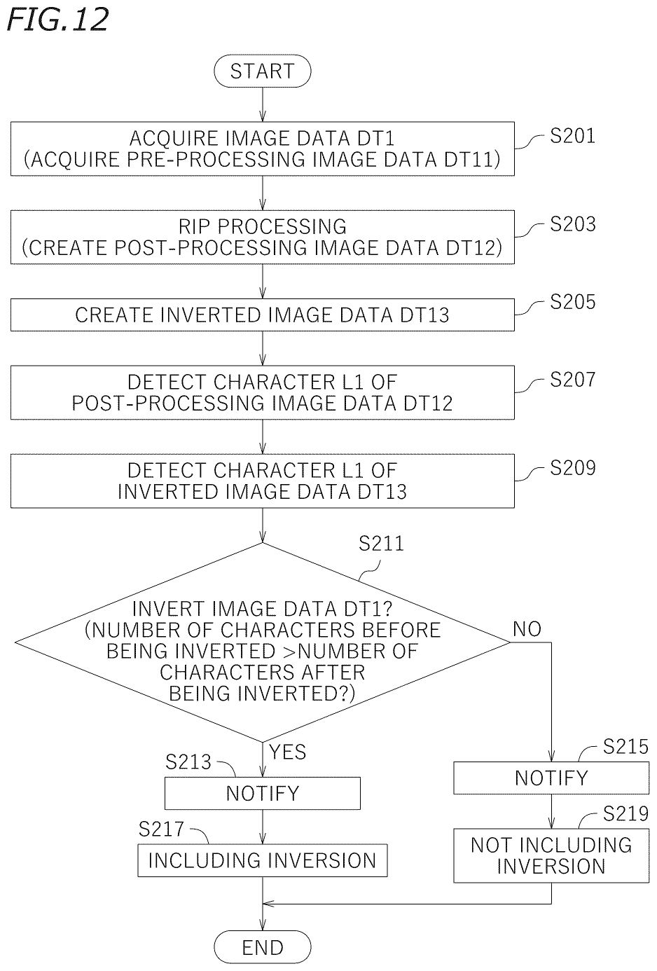

Next, in this example embodiment, steps of determining whether to invert the image data DT1 will be described in accordance with a flowchart of FIG. 12.

First, in Step S201 of FIG. 12, similar to Step S101 of FIG. 8, the acquirer 103 of FIG. 10 acquires, as the image data DT1, the pre-processing image data DT11 (see FIG. 11). Next, in Step S203 of FIG. 12, as illustrated in FIG. 11, the RIP processor 109 of FIG. 10 creates the post-processing image data DT12 by performing RIP processing on the pre-processing image data DT11.

Next, in Step S205 of FIG. 12, as illustrated in FIG. 11, the inverted data creator 113 of FIG. 10 creates the inverted image data DT13. Herein, the inverted data creator 113 creates the inverted image data DT13 by inverting the post-processing image data DT12 (specifically, inverting the post-processing image data DT12 left and right). Note that, similar to the post-processing image data DT12, the inverted image data DT13 is raster data.

Next, in Step S207 of FIG. 12, the character detector 105 of FIG. 10 detects the character L1 included in the post-processing image data DT12 of FIG. 11. Herein, the character detector 105 detects the character L1 included in the post-processing image data DT12 using the OCR technology. In this example embodiment, the character detector 105 can calculate the number of characters L1 included in the post-processing image data DT12 (which will be hereinafter also referred to as the number of characters before being inverted) from a detection result of the character L1 by the OCR technology. Note that, when the character L1 included in the post-processing image data DT12 (in other words, raster data) is inverted, the inverted character L1 is not recognized as a character in the OCR technology. Accordingly, the inverted character L1 is not counted as a character. For example, in the post-processing image data DT12 of an example of FIG. 11, characters L11, L12, and L13 are not inverted, and therefore, are recognized as characters by the OCR technology. On the other hand, in the post-processing image data DT12, a character L14 is inverted, and therefore, is not recognized as a character by the OCR technology. Therefore, in the post-processing image data DT12 of FIG. 11, the number of characters before being inverted is three.

Next, in Step S209 of FIG. 12, the character detector 105 detects the character L1 included in the inverted image data DT13 of FIG. 11. Herein, similar to Step S207, the character detector 105 detects the character L1 included in the inverted image data DT13 using the OCR technology. The character detector 105 can calculate the number of the characters L1 included in the inverted image data DT13 (which will be hereinafter also referred to as the number of characters after being inverted) from a character detection result obtained by the OCR technology. For example, in the inverted image data DT13 of the example of FIG. 11, the character L14 is not inverted, and therefore, is recognized as a character by the OCR technology, but the characters L11, L12, and L13 are inverted, and therefore, are not recognized as characters by the OCR technology. Therefore, the number of characters after being inverted in the inverted image data DT13 of FIG. 11 is one.

Next, in Step S211 of FIG. 12, the determiner 107 of FIG. 10 determines whether to invert the image data DT1. In this example embodiment, whether to invert the image data DT1 is determined by estimating whether the character L1 included in the image data DT1 is inverted. Herein, the determiner 107 compares the number of characters before being inverted and the number of characters after being inverted to each other to determine whether the number of characters before being inverted is larger than the number of characters after being inverted. Herein, when the number of characters before being inverted is larger than the number of characters after being inverted, many of the characters L1 included in the image data DT1 (specifically, the post-processing image data DT12) are non-inverted characters, and therefore, it is estimated that the transfer image A10 of the image data DT1 is an image that has not been yet inverted. In this case, the determiner 107 determines to invert the image data DT1. When the image data DT1 is to be inverted, the process proceeds to Step S213 of FIG. 12 next. Note that Step S213 is similar processing to that of Step S107 of FIG. 8, and therefore, description of Step S213 will be omitted.

On the other hand, in Step S211 of FIG. 12, when the number of characters after being inverted is equal to or larger than the number of characters before being inverted, many of the characters L1 included in the post-processing image data DT12 are already inverted characters, and therefore, it is estimated that the transfer image A10 of the image data DT1 (specifically, the post-processing image data DT12) is an already inverted image. In this case, the determiner 107 determines not to invert the image data DT1. When the image data DT1 is not to be inverted, the process proceeds to Step S215 of FIG. 12 next. Note that Step S215 is similar processing to that of Step S109 of FIG. 8, and therefore, description of Step S215 will be omitted.

Note that a text object T3 may be included in some of the characters L1 that are detection targets in the OCR technology. In this case, the image data DT1 can be vector data. In this case, in Step S211, in determining whether to invert the image data DT1, the number of non-inverted characters (or the number of inverted characters) based on inversion setting information T4 of the text object T3 may be compared to the total number of characters that is a sum of the number of characters before being inverted and the number of characters after being inverted detected by the OCR technology. For example, the determiner 107 may be configured or programmed to determine, when the number of non-inverted characters based on the inversion setting information T4 exceeds a half of the total number of characters, to invert the image data DT1. On the other hand, the determiner 107 may be configured or programmed to determine, when the number of inverted characters based on the inversion setting information T4 exceeds the half of the total number of characters, not to invert the image data DT1.

In this example embodiment, in FIG. 12, after Step S213, Step S217 is executed. In Step S217, the RIP processor 109 of FIG. 10 inverts the post-processing image data DT12 since it has been determined by the determiner 107 that the image data DT1 is to be inverted. In other words, the RIP processor 109 replaces the inverted image data DT13 (see FIG. 11) described above as the post-processing image data DT12.

Herein, in FIG. 12, after Step S215, Step S219 is executed. In Step S219, the RIP processor 109 does not invert the post-processing image data DT12 since it is determined by the determiner 107 not to invert the image data DT1.

As described above, in this example embodiment, similar to the first example embodiment, whether to invert the image data DT1 can be automatically determined based on information of whether the character L1 included in the image data DT1 is inverted. Accordingly, the user is not required to manually invert the image data DT1, and therefore, the image data DT1 that is needed to be inverted can be properly determined.

In this example embodiment, the character detector 105 detects the character L1 using optical character recognition (herein, the OCR technology) on the post-processing image data DT12 in Step S207 of FIG. 12. As described above, by using optical character recognition, even in raster data that does not include the text object T1, the character L1 can be detected.

In this example embodiment, the inverted data creator 113 of the data inversion determination device 100A creates the inverted image data DT13 (see FIG. 11) obtained by inverting the post-processing image data DT12 in Step S205 of FIG. 12. The character detector 105 detects the character L1 using optical character recognition on both the post-processing image data DT12 and the inverted image data DT13 in Step S207 and Step S209 of FIG. 12. In Step S211 of FIG. 12, when the number of characters in the post-processing image data DT12 (herein, the number of characters before being inverted) is larger than the number of characters of the inverted image data DT13 (herein, the number of characters after being inverted), the determiner 107 determines to invert the image data DT1. When the number of characters before being inverted is larger than the number of characters after being inverted, it is estimated that the transfer image A10 of the image data DT1 is highly likely an image before being inverted and it is needed to invert the image data DT1. Accordingly, whether it is needed to invert the image data DT1 can be properly determined by comparing the number of characters before being inverted and the number of characters after being inverted to each other.

Note that, in this example embodiment, the character detector 105 may be configured or programmed to detect the character L1 using the OCR technology on the pre-processing image data DT11. In this case, the pre-processing image data DT11 may be raster data. In this case, the inverted data creator 113 may be configured or programmed to create the inverted image data DT13 by inverting the pre-processing image data DT11. The determiner 107 may be configured or programmed to determine, when the number of characters of the pre-processing image data DT11 is larger than the number of characters of the inverted image data DT13, to invert the image data DT1.

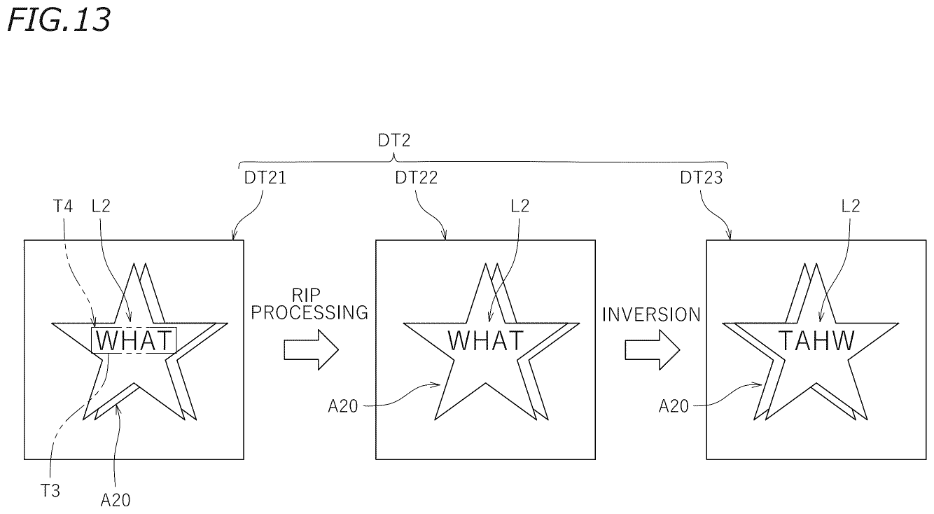

Next, a modified example of the second example embodiment will be described. FIG. 13 is a diagram illustrating image data DT2 in the modified example. In FIG. 13, the image data DT2 includes a transfer image A20. The image data DT2 includes pre-processing image data DT21 before RIP processing is performed thereon and post-processing image data DT22 after RIP processing has been performed thereon. Data obtained by inverting the post-processing image data DT22 is inverted image data DT23. For example, as illustrated in FIG. 13, when “WHAT” is included as characters L2 in the post-processing image data DT22, the number of characters before being inverted in the post-processing image data DT22 is four. On the other hand, in the inverted image data DT23 obtained by inverting the post-processing image data DT22, the characters L2 can be “TAHW.” In this case, in the OCR technology, even inverted characters can be recognized as characters, and therefore, the number of characters after being inverted in the inverted image data DT23 is four.

As described above, the determiner 107 may be configured or programmed to determine whether to invert the image data DT2, based on the inversion setting information T4 included in the text object T3 of the pre-processing image data DT21 when the characters L2 that can be recognized as inverted characters are included in the image data DT, that is, for example, when the number of the characters before being inverted and the number of characters after being inverted match each other. Herein, the text object T3 corresponding to “WHAT” may be a graphic object. The determiner 107 may be configured or programmed to determine, when the inversion setting information T4 of the text object T3 corresponding to “WHAT” is the non-inverted information in the pre-processing image data DT21, to invert the image data DT2 and next, in Step S217 in FIG. 12, the post-processing image data DT22 may be inverted. On the other hand, the determiner 107 may be configured or programmed to determine, when the inversion setting information T4 of the text object T3 corresponding to “WHAT” is the inverted information in the pre-processing image data DT21, not to invert the image data DT2 and next, in Step S219 of FIG. 12, the post-processing image data DT22 may not be inverted. As described above, even when the characters L2 included in the image data DT2 are characters that can be recognized as characters after being inverted, whether to invert the image data DT2 can be automatically determined, and therefore, the image data DT2 that is needed to be inverted can be properly determined.

Note that, in the first and second example embodiments, a data inversion determination method is realized. Herein, the data inversion determination method includes an acquisition step, a character detection step, a determination step, a RIP processing step, a notification step, and an inverted data creation step. The acquisition step, the character detection step, the determination step, RIP processing step, the notification step, and the inverted data creation step are embodied by the acquirer 103, the character detector 105, the determiner 107, the RIP processor 109, the notifier 111, and the inverted data creator 113, respectively.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A data inversion determination device comprising:
an acquirer configured or programmed to acquire image data that is a print target;
a character detector configured or programmed to detect a character from the image data acquired by the acquirer; and
a determiner configured or programmed to estimate whether the character detected by the character detector is inverted to determine whether to invert the image data.

2. The data inversion determination device according to claim 1, wherein
the image data includes pre-processing image data that is vector data before RIP processing is performed thereon;
the character is a text object included in the vector data; and
the character detector is configured or programmed to detect, as the character, a portion of the pre-processing image data detected as the text object.

3. The data inversion determination device according to claim 2, wherein
the text object incudes inversion setting information indicating whether the character is inverted; and
the determiner is configured or programmed to determine whether to invert the image data, based on the inversion setting information.

4. The data inversion determination device according to claim 3, wherein
the inversion setting information includes inverted information indicating that the character is inverted and non-inverted information indicating that the character is not inverted; and
the determiner is configured or programmed to determine, when a number of the characters the inversion setting information of which is the non-inverted information is larger than a number of the characters the inversion setting information of which is the inverted information, to invert the image data.

5. The data inversion determination device according to claim 1, wherein
the image data includes:
pre-processing image data before RIP processing is performed thereon; and
post-processing image data that is raster data after RIP processing has been performed thereon; and
the character detector is configured or programmed to detect the character using optical character recognition on either one of the pre-processing image data or the post-processing image data.

6. The data inversion determination device according to claim 5, further comprising:
an inverted data creator configured or programmed to create inverted image data obtained by inverting either one of the pre-processing image data or the post-processing image data; wherein
the character detector is configured or programmed to detect the character using optical character recognition on both the inverted image data and the either one of the pre-processing image data or the post-processing image data; and
the determiner is configured or programmed to determine, when a number of the characters of either one of the pre-processing image data or the post-processing image data is larger than a number of the characters of the inverted image data, to invert the image data.

7. The data inversion determination device according to claim 1, wherein
the image data includes:
pre-processing image data before RIP processing is performed thereon; and
post-processing image data after RIP processing has been performed thereon; and
the data inversion detector includes a RIP processor configured or programmed to RIP-process and invert, when it is determined by the determiner to invert the image data, the pre-processing image data to create the post-processing image data.

8. The data inversion determination device according to claim 1, further comprising:
a notifier configured or programmed to notify a user of a determination result obtained by the determiner.

9. A printing system comprising:
the data inversion determination device according to claim 7; and
a printer; wherein
the printer is configured to perform printing on a medium, based on the post-processing image data created by the RIP processor of the data inversion determination device.

10. A data inversion determination method comprising:
acquiring image data that is a print target;
detecting a character from the image data acquired in the acquiring; and
estimating whether the character detected in the detecting is inverted to determine whether to invert the image data.
